(19) United States
(12) Patent Application Publication
(10) Pub. No.: US 2012/0298713 A1
(43) Pub. Date: Nov. 29, 2012

(54) Magazine For A Nailer And The Like

(75) Inventor: Marco RONCONI, Bologna (IT)

(73) Assignee: FASCO S.R.L., Granarolo dell'Emilia (BO) (IT)

(21) Appl. No.: 13/476,682

(22) Filed: May 21, 2012

(30) Foreign Application Priority Data
May 25, 2011 (IT) BO2011A000303

(51) Int. Cl. B25C 1/00

(52) U.S. Cl. 227/120

(57) ABSTRACT

The present invention relates to a magazine device for a nailer for supplying an ejection chamber with first nails having lengths in a first range or with second nails having lengths in a second range shorter than the lengths of the first nails. The magazine device has at least one sliding channel laterally delimited by two side walls (5, 6) where, in an operating condition, the sliding channel exits into a nail ejection chamber (E). The device (1) has at least one window (8) provided in one side wall facing the respective sliding channel (3). The window has a dimension (H) perpendicular to a longitudinal dimension of the sliding channel equal to or larger than a maximum transverse dimension of the sliding channel. The window has a dimension (L) parallel to the longitudinal dimension of the sliding channel equal to or smaller than a maximum nail length.

### TECHNICAL FIELD

The present invention relates to fixing tools and in particular to a magazine device for a nailer and the like suitable to supply an ejection chamber of the nailer with a first type of nail having lengths in a first range or with a second type of nail having lengths in a second range which is shorter than the lengths of the first nail type.

### BACKGROUND

There are known magazines for nailers having a sliding channel for nail sticks which have lengths in a determined and limited range of values. There are also known magazine devices provided with two channels which each receive nail sticks having respective predetermined lengths. The known magazine devices have supply openings for receiving the nail sticks placed either above or behind the magazine where when nailing, the nails are received in an upside condition as the objects are horizontally placed.

A disadvantage of said known devices consists in having a lot of limitations about the utilizable nail types and in particular they cannot use the current types of nails which are very short with a leg length variable between about 25 mm and 40 mm. They can only use a type of nail having leg lengths variable between a minimum of about 50 mm up to about 90-100 mm.

There are also known magazines having screw-type or the like couplers for use with a nailer.

A disadvantage of the known magazines consists in that they are very complex and needs a lot of time to detach and to connect the magazines to the nailer which is inconvenient and unpractical and results in jamming or the necessity of some other intervention on the same magazine.

### SUMMARY OF THE INVENTION

An object of the present invention is to provide a magazine device for a nailer and the like that allows the use of traditional nail sticks having lengths comprised in a first range of values or nail sticks particularly of short lengths, that is, in a second range of values smaller than those of the first range.

Another object is to propose a magazine device for a nailer or another similarly device, equipped with a connector that allows very quick detachments and connections of the magazine device to the nailer which are also virtually gapless.

### BRIEF DESCRIPTION OF THE DRAWINGS

The characteristics of the invention are evidenced in the following with particular reference to the attached drawings, in which:

FIG. 1 is a side view of a magazine device for a nailer and the like which is the object of the present invention, partially sectioned and connected to a respective nailer which is only partially shown;

FIG. 2 is an opposite side partial view of the device shown in FIG. 1;

FIG. 3 is a partial top view of the device of FIG. 1;

FIG. 4 is an enlarged view of a section taken along the plane IV-IV of FIG. 1;

FIG. 5 is an enlarged sectional view taken along the plane V-V of FIG. 1;

FIGS. 6, 7 is enlarged sectional views taken along the plane VI-VI of FIG. 1 in which the device is supplied with respective types of nail sticks;

FIG. 8 is an enlarged sectional view taken along the plane VIII-VIII of FIG. 1.

### DETAILED DESCRIPTION OF THE INVENTION

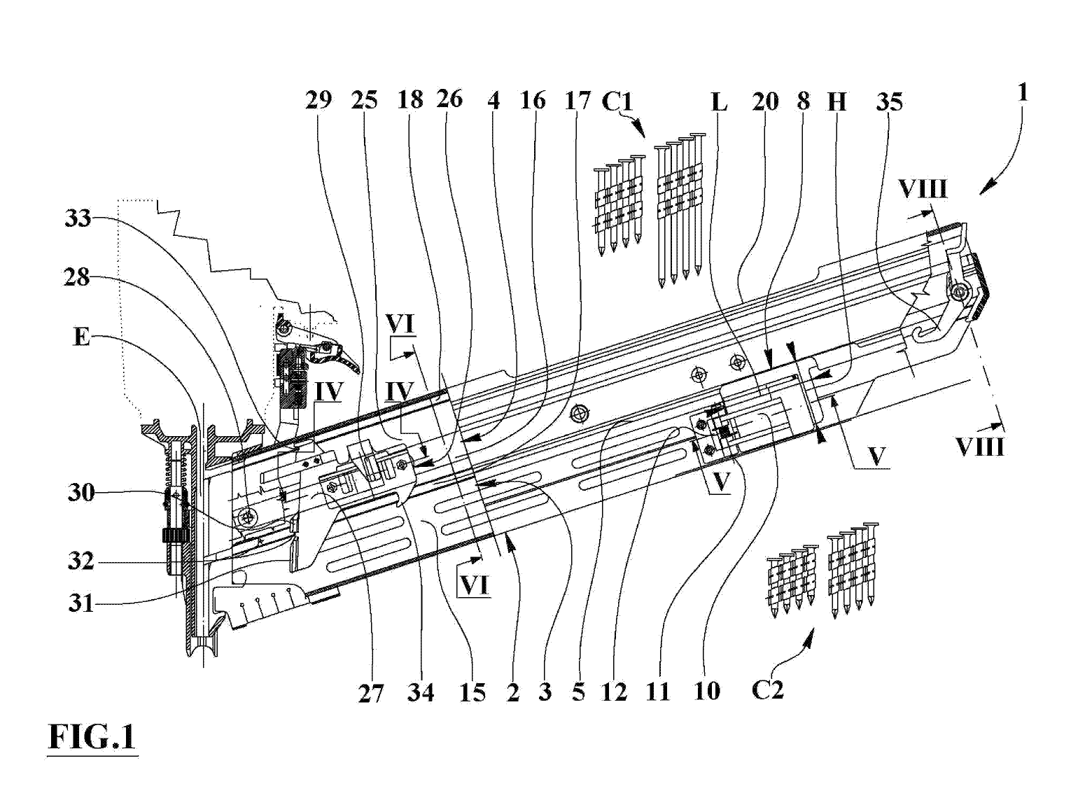

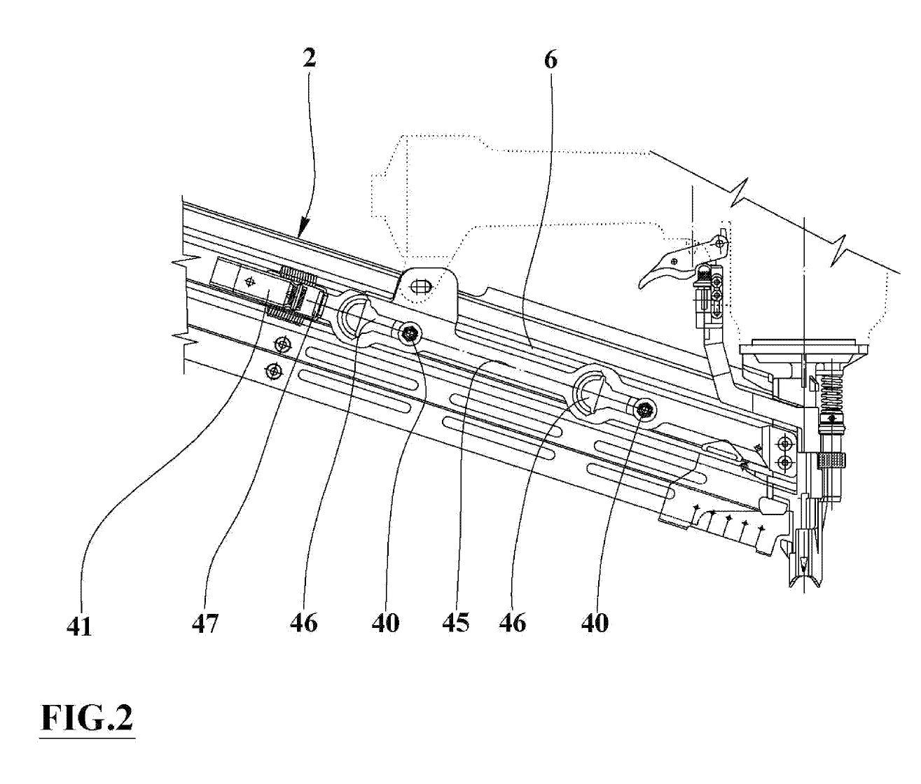

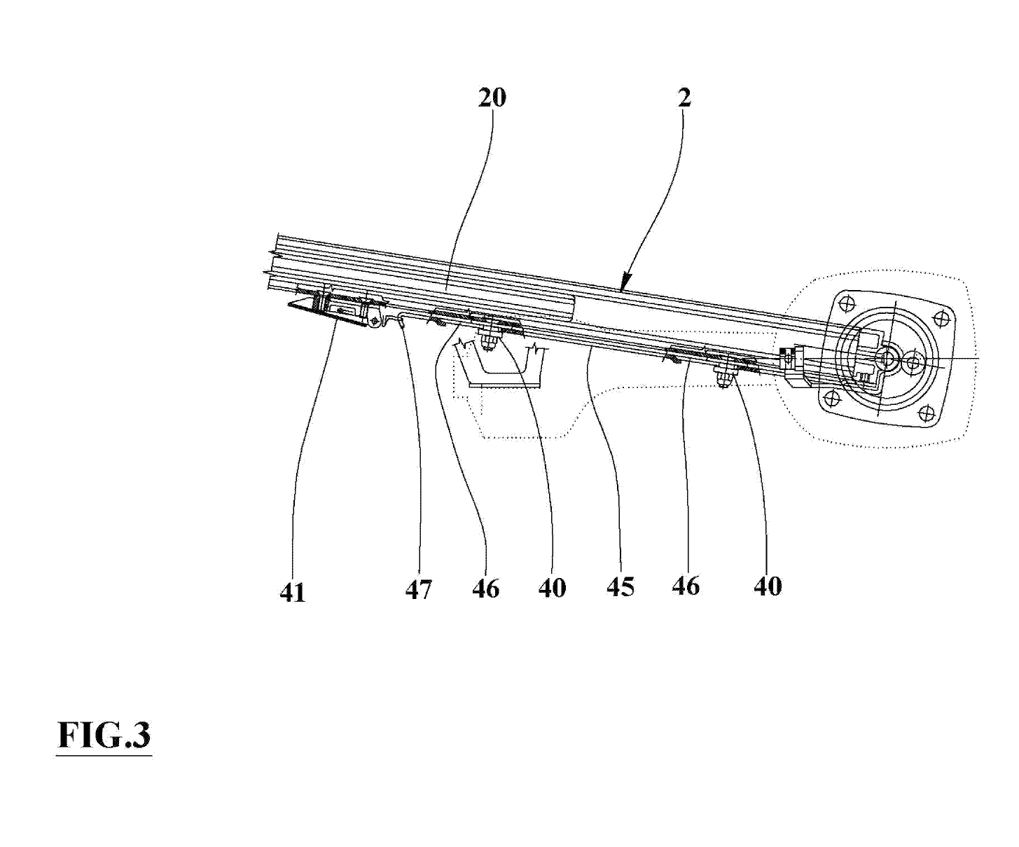

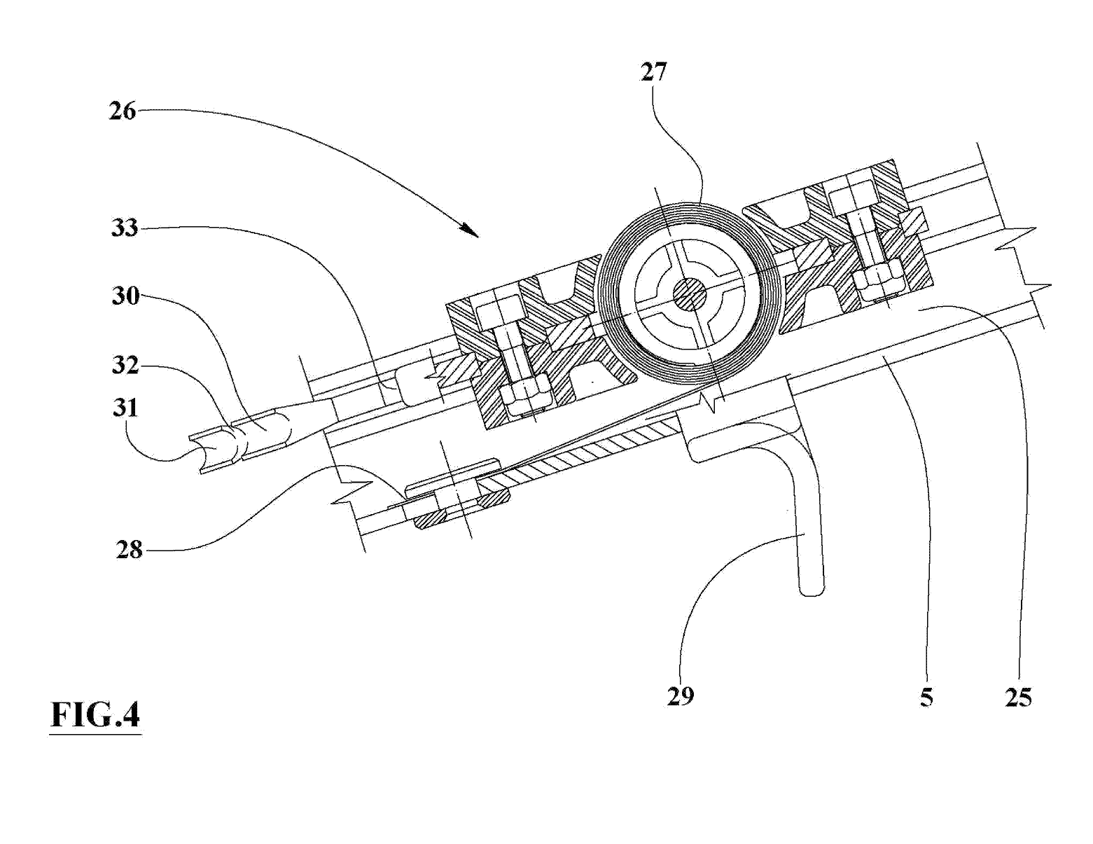

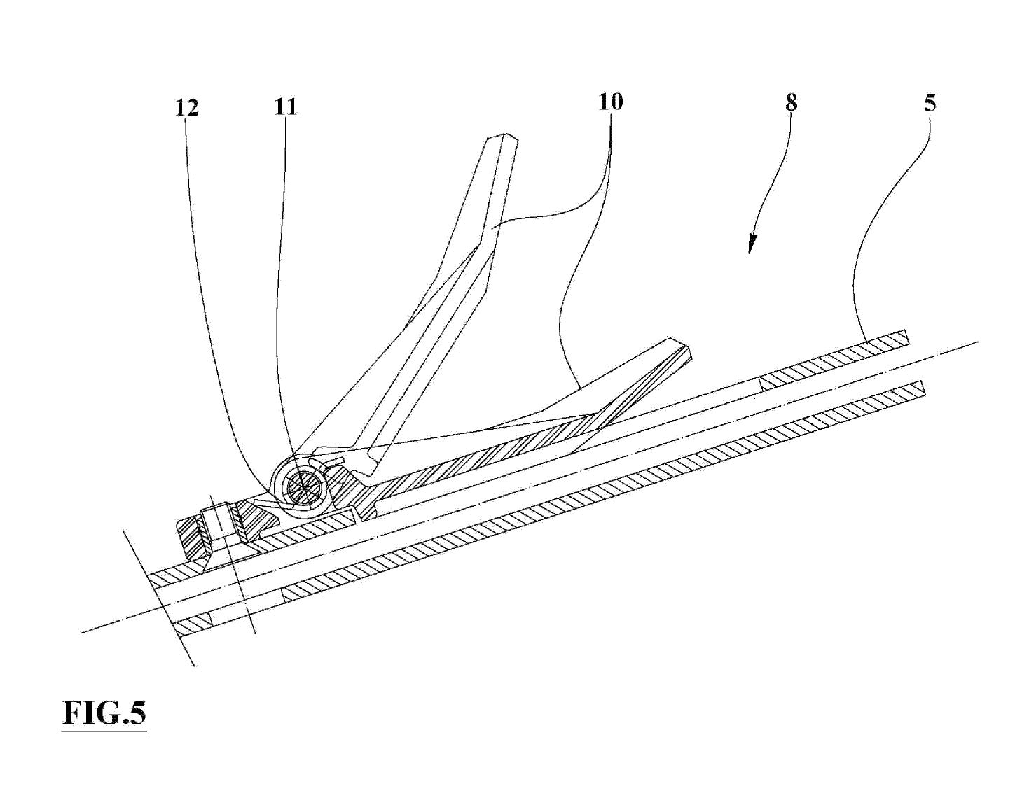

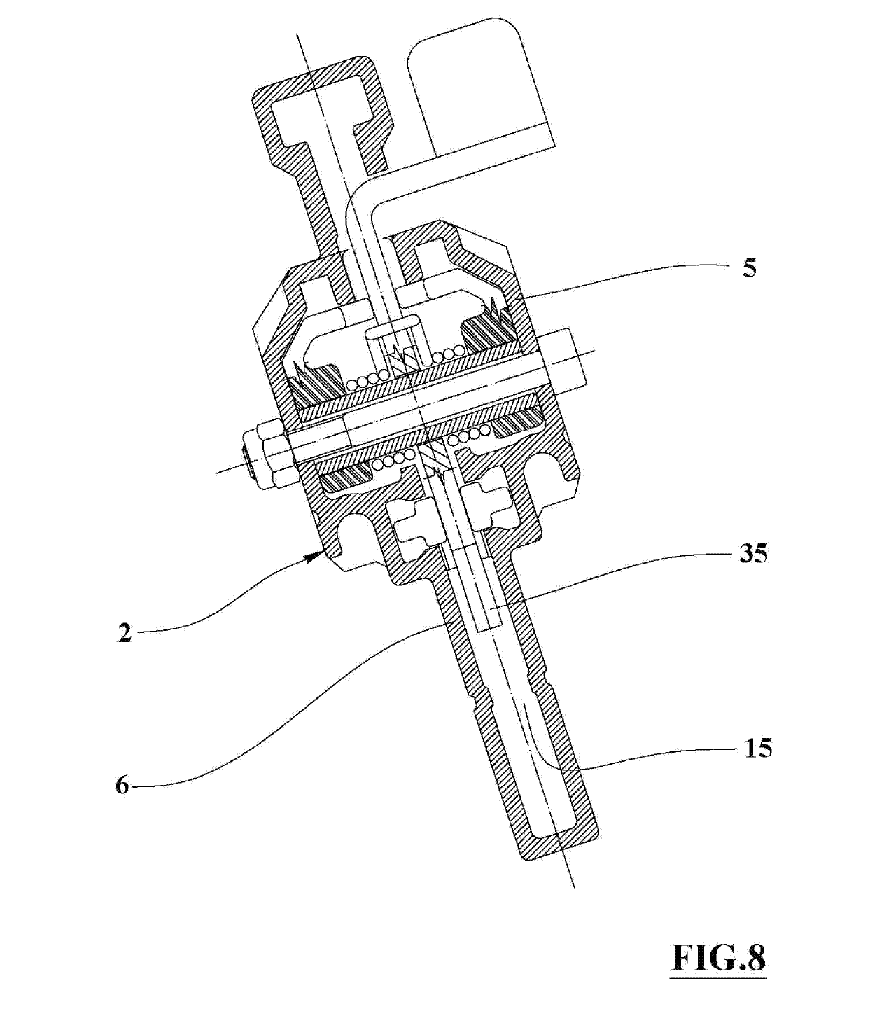

Referring to FIGS. 1-8, a magazine device 1 for a nailer and the like, which is the object of the present invention, is provided with a body 2, preferably consisting of a section bar, for example made of aluminum, internally provided with two sliding channels, a first channel 3 and a second channel 4, whose geometric median longitudinal planes are coincident.

The sliding channels 3, 4 are sideways delimited by two side walls 5, 6 of the body 2 of the device 1.

Each of the channels 3, 4 has a respective cavity 15, 16 between side walls 5, 6 of device body 2. Furthermore, each of the channels 3, 4 comprises a respective enlarged longitudinal seat 17, 18.

The maximum transverse extension of the cavity 15 of the first channel 3 is lower than the maximum transverse extension of the cavity 16 of the second channel 4. Preferably the first channel 3 exits to the ejection chamber E at the end portion of the same ejection chamber E exit. Referring to FIG. 1, the first channel 3 is lower than the second channel 4, and each longitudinal seat 17, 18 is higher than the corresponding cavity 15, 16. The cavities have very flattened and elongated parallelepiped shapes while the longitudinal seats have elongated parallelepiped shapes with rectangular transverse sections.

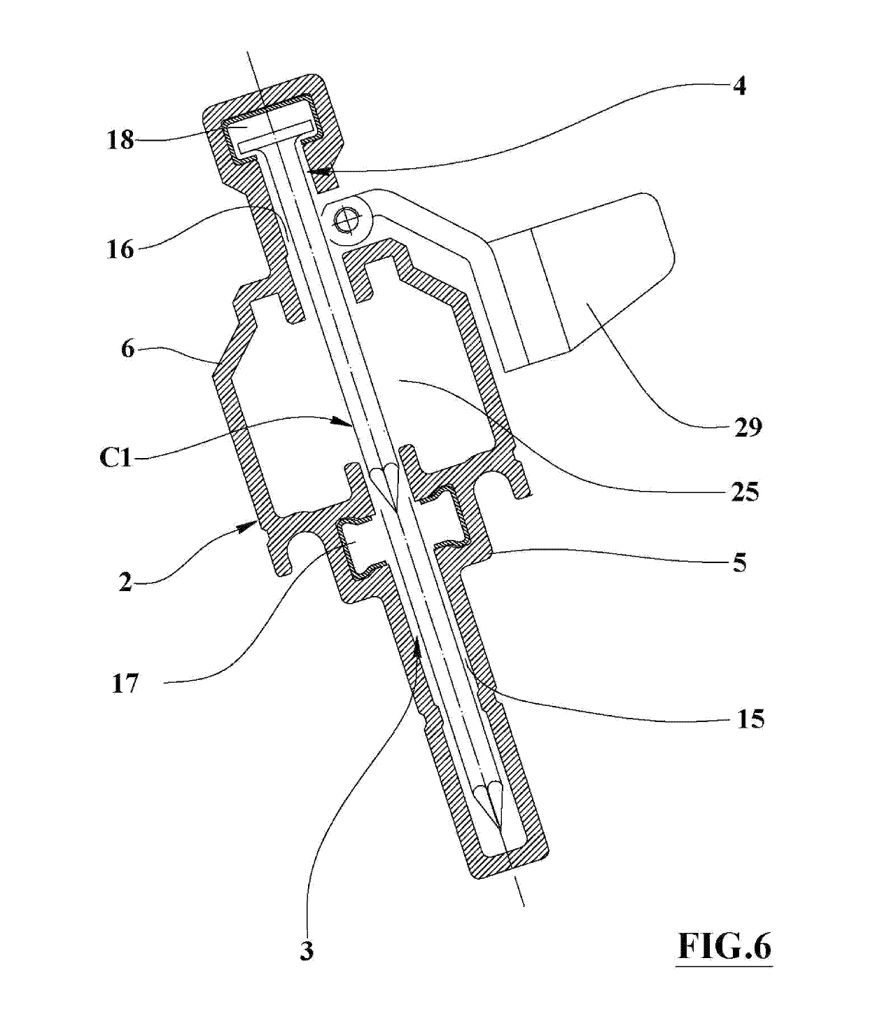

As clearly visible for example in FIG. 6, the lower longitudinal portion of the longitudinal seat 18 of the second sliding channel 4 opens into the cavity 16 of the same second sliding channel 4. The lower longitudinal portion of the cavity 16 of the second sliding channel 4 exits into an upper longitudinal portion of the longitudinal seat 17 of the first sliding channel 3. The lower longitudinal portion of the longitudinal seat 17 opens exiting to the cavity 15 of the first sliding channel 3.

Therefore, the cavities 15, 16 and the enlarged longitudinal seats 17, 18 of the first sliding channel 3 and the second sliding channel 4 are each other connected and define a single inner cavity of the body 2.

In this way, the device 1 is able to accommodate a first nail type C1, separated or joined in a known way to form sticks or short tapes, and having lengths comprised for example between 50 mm and 90 mm or a little more and to accommodate a second nail type C2 having lengths comprised, for example, between 25 mm or less and 40 mm or a little more. The heads of the nails C1 of the first type are smoothly accommodated in the longitudinal seat 18 of the second sliding channel 4 and their shanks slide in the cavity 16 of the second sliding channel 4 and, if such nails C1 are particularly long, they scroll also in the longitudinal seat 17 and in the cavity 15 of the first sliding channel 3.

The heads of the nails C2 of the second type are smoothly accommodated in the longitudinal seat 17 of the first sliding channel 3 and their shanks slide in the cavity 15 of the same first sliding channel 3.

In an operating condition of the device when connected to the nailer, as shown in FIGS. 1-3, the sliding channels 3, 4 exit into an ejection chamber E for the nails of the first type C1 or the second type C2, alternatively supplied by the device 1.

One of the sidewalls 5 of the body 2 of the device 1 is provided with a passing-through window 8 obtained through the wall and facing the first sliding channel 3 so connecting to the outside. This window 8 has a dimension H perpendicular to the longitudinal geometric axis of the first sliding channel 3 equal or slightly larger than the maximum dimension of the transverse section of the sliding channel 3. In other words, the height of the window is almost equal or slightly higher than the height maximum of the second nail type C2.

The dimension L of the window 8 parallel to the first sliding channel 3 is equal or smaller than the maximum length of the nail stick, wherein the shorter this parallel dimension L can be, the more flexible the nail stick.

The device 1 includes a small door 10 coupled by a hinge 11 to the side of the window 8 closer to the outlet of the sliding channels 3, 4 in the chamber E.

The small door 10 has a size approximately corresponding to the size of the corresponding window 8 and is elastically maintained in a closing condition by an elastic means 12, for example an helicoidal spring, associated with the hinge 11. The second channel 4 is provided on the upper part with a longitudinal input opening 20 obtained through the wall of the body 2 opposite to the first channel 3 and having longitudinal and transverse dimensions equal or slightly larger respectively than the maximum length of the stick of the first nail type C1 and at the maximum dimension of the heads of the nails C1.

As an alternative, the invention is conceived in such a way that each channel 3, 4 can be provided with a respective window 8, for example one window obtained in a side 5 and another window in the other side 6.

The inner cavity of the body 2 comprises a longitudinal recess 25 for the sliding of a trolley device 26 fit to press the nails towards the ejection chamber E.

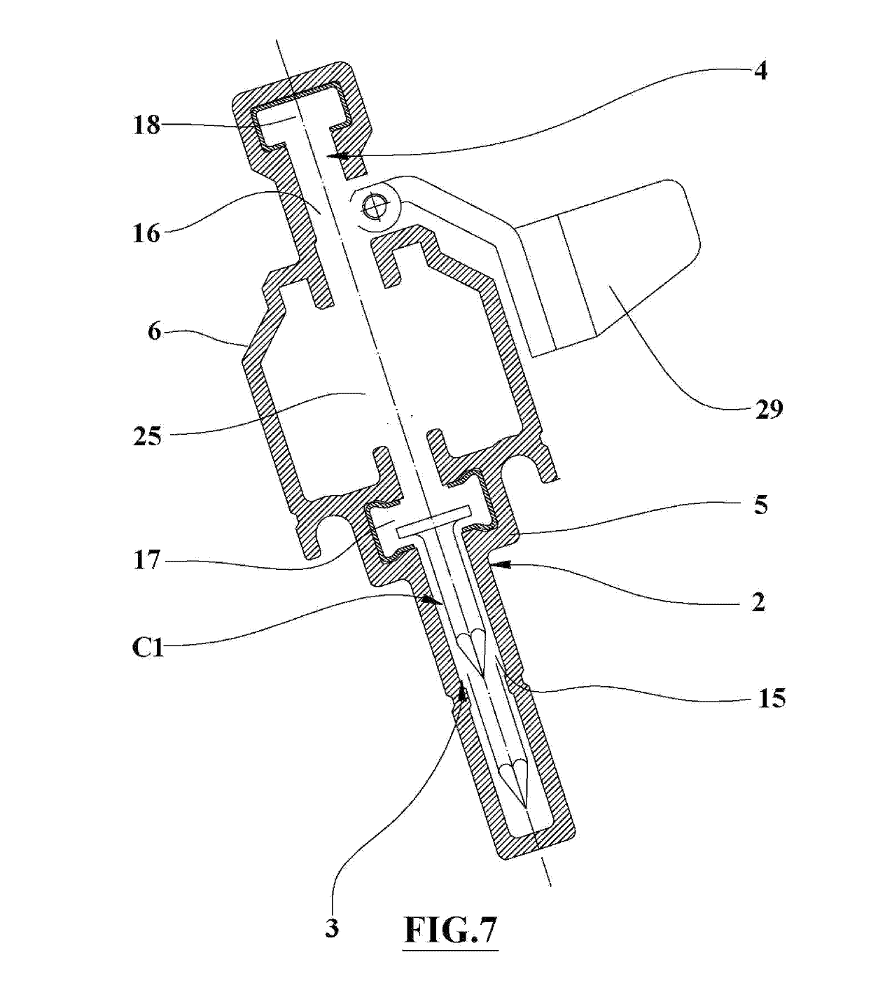

This longitudinal recess 25 is visible in FIG. 1 and in FIGS. 6 and 7 where it is shown extending from both longitudinal sides of the cavity 16 of the second channel 4 to which it is therefore connected.

The trolley device 26 is provided with a seat, equipped with a side opening, for the free rotation of a spiral wound belt spring 27. An external portion of this spring crosses the side opening and the respective end 28 is blocked to the end of the body 2 adjacent to the ejection chamber E to transmit to the trolley device 26 the elastic force directed towards this chamber E. The trolley device 26 is also provided with a handle 29 accessible from the outside and has a hangeable tooth 34 hinged to a removable stop means 35 located at the end of the body 2 opposite to the chamber E and manually detachable therefrom.

The side of the trolley device 26 facing the ejection chamber E has contact portions 30, 31, for example concave shaped portions, for contacting the free portions of the nails shanks and having two recesses, a first recess 32 and a second recess 33 assigned to accommodate nail heads of the first nail type C1 and the second nail type slidable respectively in the first channel 3 and second channel 4.

An external side face of the body 2 of the device has two protruding pins 40 with respective mushroom-shaped heads and a lever closure 41, preferably of type with elastic members, and aligned to the joint of the two protruding pins 40.

The nailer is provided with a protruding arm 45 having two slots with holes for the door-lock 46 for receiving the two protruding pins 40. The free end of this protruding arm 45 is equipped with a connection 47 for the lever closure 41.

In the operating condition, the function of the device 1 provides that one of the first sliding channel 3 or second sliding channel 4 is charged through the window 8 or the input opening 20 with sticks of nails respectively of the second type C2 or of the first type C1 allowing the nailer to use both nail types.

An advantage of the present invention is to supply a magazine device for a nailer and similar devices, that allows use of sticks of nails of traditional lengths comprised in a first range of values or sticks of nails which are short, having lengths comprised in a second range of values smaller than those of the first range.

Another advantage is to supply a magazine device for a nailer and similar devices provided with a connection to the nailer that allow very fast detachments and connections of the magazine device to the nailer and which is virtually gapless.

1) A magazine device for supplying a nailer and similar devices comprising:
at least one sliding channel (3, 4) for nail sticks laterally delimited by two side walls (5, 6) of a body (2) of the device (1) where, in an operating condition of the device connected to the nailer, the at least one sliding channel (3, 4) exits into a nails ejection chamber (E) of said nailer;
at least one window (8) provided in one of the side walls (5, 6) of the device body (2) facing the respective sliding channel (3), the at least one window (8) having a dimension (H) perpendicular to a longitudinal dimension of the at least one sliding channel (3) equal to or larger than a maximum transverse dimension of said sliding channel (3), said window (8) having a dimension (L) parallel to the longitudinal dimension of the at least one sliding channel (3) equal to or smaller than a maximum length of the stick of nails.

2) The device according to claim 1 further comprising a flap (10) hinged by a hinge (11) to the side of the window (8) closer to an exit mouth of the at least one sliding channel (3, 4) and having dimensions roughly corresponding to those of the corresponding window (8), the flap (10) elastically maintained in a closed condition by an elastic means (12) associated to the hinge (11).

3) The device according to claim 1 wherein the at least one sliding channel comprises a first sliding channel (3), and further comprising a second sliding channel (4), whose median longitudinal planes are the same or nearly the same, said first (3) and second (4) sliding channels partially overlapping;
each of said first and second sliding channels (3, 4) having a cavity (15, 16) for the sliding of nail stems, each cavity comprised between side walls thereof, and each of said channels (3, 4) including a corresponding enlarged longitudinal seat (17, 18) for the sliding of the heads of the respective nail sticks.

4) The device according to claim 3 wherein the maximum transverse extension of the cavity (15) of the first channel (3) is smaller than the maximum transverse extension of the cavity (16) of the second channel (4) and the second channel has an outlet end portion that exits into the ejection chamber (E) close to the outlet end portion of the first channel.

5) The device according to claim 3 wherein each channel (3, 4) has a respective window (8) having longitudinal and transverse dimensions equal to, or respectively slightly larger than the length of the nail stick and than the maximum dimension of the nail heads.

6) The device according to claim 3 wherein the first channel (3) has a window (8) and the second channel (4) has an input opening (20) carried out through the body (2) portion opposite to the first channel (3), the window and input opening having longitudinal and transverse dimensions equal to, or respectively slightly larger than the length of their respective nail sticks and than the maximum dimension of their respective nail heads

7) The device according to claim 3 wherein the cavities (15, 16) and the enlarged longitudinal seats (17, 18) of the first sliding channel (3) and the second sliding channel (4) are connected and define a single cavity inside the body (2).

8) The device according to claim 7 wherein the inner cavity of the body (2) comprises a longitudinal recess (25) for the sliding translation of a trolley means (26) assigned to press the nails towards the ejection chamber (E).

9) The device according to claim 8 wherein the trolley means (26) are provided with a wrapped band spring (27) having an end (28) locked to an end of the body (2) adjacent to the ejection chamber (E) to transmit to the trolley means (26) the elastic force directed towards said ejection chamber (E), the trolley means (26) being provided with a handle (29) accessible from an outside thereof and having a tooth (34) for coupling with a removable stopping means (35) hinged to the body (2) end opposite to the chamber (E) and being manually detachable therefrom.

10) The device according to claim 8 wherein a side of the trolley means (26) facing the ejection chamber (E) has contact portions (30, 31) assigned to contact the free portions of the nail stems and has two recesses, a first recess (32) and a second recess (33), assigned to house the nail heads sliding respectively in the first channel (3) and in the second channel (4).

11) The device according to claim 1 wherein an external side wall of the body of said device has two protruding pins (40) with respective mushroom shaped heads and further comprising a clamping lock (41), aligned with a line joining the two protruding pins (40), the nailer being provided with a protruding arm (45) having two lock hole shaped slots (46) for two protruding pins (40) and having, at its free end, a coupler (47) for the clamping lock (41).

12) The device according to claim 11 wherein the clamping lock is equipped with elastic elements.
